(19) United States
(12) Patent Application Publication
(10) Pub. No.: US 2012/0009303 A1
(43) Pub. Date: Jan. 12, 2012

(54) Method for Producing Reduced Fat Layered Baked Product

(75) Inventor: Ximena Quintero Fuentes, Flower Mound, TX (US)

(73) Assignee: FRITO-LAY NORTH AMERICA, INC., Plano, TX (US)

(21) Appl. No.: 12/831,363

(22) Filed: Jul. 7, 2010

(51) Int. Cl. A21D 8/02; A21D 13/00; A23P 1/10

(52) U.S. Cl. 426/94; 426/297; 426/502; 426/19

(57) ABSTRACT

A method for producing a reduced fat, layered baked product and the resulting product. A main dough is provided and formed into a sheet. Frozen dough or ice is encased by the main dough to form two layers of main dough separated by a layer of frozen dough or ice. The layered dough may be rolled out and folded repeatedly to form more layers. The layered dough is then sheeted, cut, proofed and baked to form a reduced fat, layered, flakey baked product.

### BACKGROUND OF THE INVENTION

1. Technical Field

The present invention relates to a method for producing a reduced fat, layered baked good and the resulting reduced fat product.

2. Description of Related Art

Layered, flakey baked goods are generally known as puff pastries. In a broad sense, puff pastries are made from a dough that is layered with fat and repeatedly folded and rolled out to form a dough with many dough layers separated by layers of fat. Butter and hydrogenated vegetable oils are the most common substances used for the fat layers. During baking of the layered dough, steam is formed and evaporated causing the expansion of the dough layers. The fat insulates the dough layers, allowing each to cook individually and puff the pastry. The finished product is a light and flakey baked good.

In recent years, however, consumer demand has been dramatically increasing for foods having less fat content. The traditional method of producing puff pastries results in a product with a high fat content, which is undesirable in a market searching for low fat alternatives. Removing the fat between layers, however, adversely affects the organoleptic properties of the end product. Thus, it would be desirable to produce a layered, flakey baked product with a lower fat content that has organoleptic properties similar to the traditional puff pastries.

### SUMMARY OF THE INVENTION

The present invention provides a method for producing a reduced fat, layered baked good and the resulting product. A substance with a lower fat content than the substances used in prior art methods is substituted to create a reduced fat, layered baked good.

In one aspect, frozen dough is used to form a layered dough. A main dough is provided and formed into a sheet. A frozen dough is provided and formed into a sheet. The sheet of frozen dough is encased by the sheet of main dough to form a folded dough. The folded dough is rolled out and folded repeatedly to form a multi-layered dough. The multi-layered dough is then sheeted to a specified thickness, cut into a desired shape, proofed and baked to a specified moisture content.

In one aspect, ice is used to form a layered dough. A main dough is provided and formed into a sheet. Ice, which is preferably shaved ice and may consist of frozen water, frozen fruit juice or frozen vegetable juice, is placed on the main dough sheet. The layer of ice is encased by the sheet of main dough to form an ice-layered dough. The ice-layered dough is then sheeted to a specified thickness, cut into a desired shape, proofed and baked to a specified moisture content.

The final product resulting from the method of the present invention is a layered, flakey baked good with substantially less fat than products made with prior art methods that maintains the desirable organoleptic properties of traditional puff pastries.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart depicting a preferred embodiment of the method of Applicant's invention using frozen dough; and

FIG. 2 is a flow chart depicting a preferred embodiment of the method of Applicant's invention using shaved ice.

### DETAILED DESCRIPTION

The present invention involves a method for producing a reduced fat, layered baked good and the resulting product. Prior art methods employ butter or fat, both of which are solids at room temperature, in the production of puff pastries to separate layers of dough. Substituting the fat or butter with a another solid substance having a lower fat content results in a similar layered, flakey baked good with substantially less fat than the puff pastries produced by the prior art methods that maintains desirable organoleptic properties. Preferably, the method of the claimed invention described below is a continuous process, but it may also be practiced as a batch process.

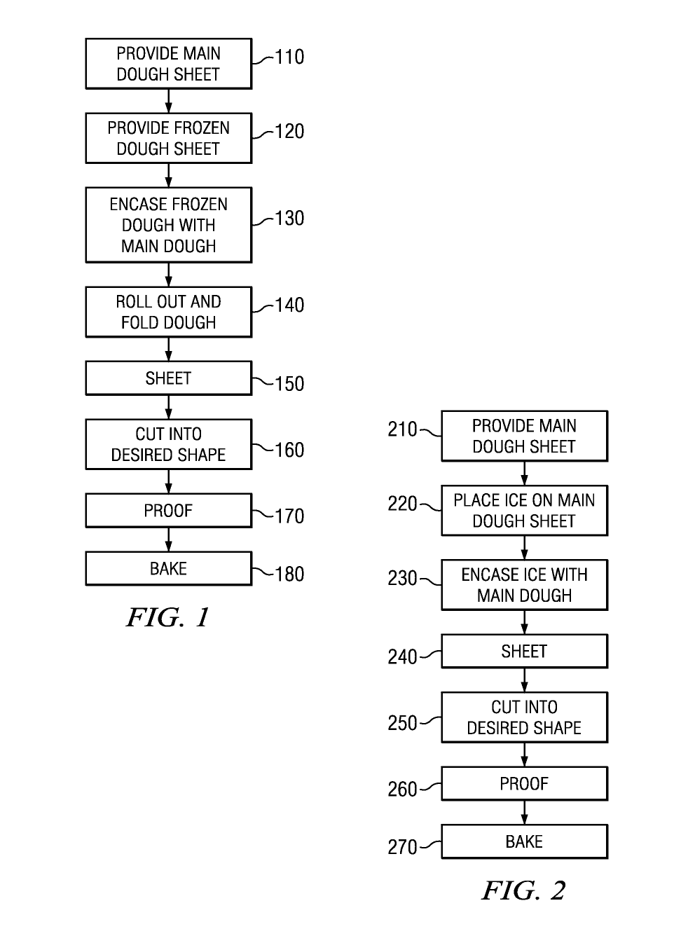

In an embodiment of the present invention, frozen dough is used in place of the fat or butter. Referring to FIG. 1, the first step is to provide 110 a main dough sheet. The main dough may be prepared or bought ready-made. In one embodiment, the main dough is prepared with a composition of about 55% to 65% hard winter wheat flour, about 0.3% to 0.5% granulated sugar, about 3% to 5% vital wheat gluten, about 1% to 3% garlic powder, about 1% to 2% flour salt, about 1% to 2% yeast, and about 25% to 35% water. The dry ingredients are mixed together for about 1 minute and then water at a temperature of about 20° F. to 40° F. is added. The dough is mixed at a lower speed for about 3 minutes and then at a higher speed for about 6 minutes. After the dough has been mixed thoroughly, the dough is allowed to ferment for about 20 to 40 minutes at a temperature of about 80° F. to 85° F. The main dough is then formed into a sheet.

Next, a frozen dough sheet is provided 120. As with the main dough, the frozen dough may be prepared or bought ready-made. In one embodiment, the frozen dough is prepared with a composition of about 25% to 35% of hard winter wheat flour, about 25% to 35% of natural pregelatinized starch, and about 35% to 45% water. The dry ingredients are mixed together for about 1 minute and then water at a temperature of about 40° F. is added. The dough is mixed at a low speed for about 3 minutes and then at a higher speed for about 6 minutes. The dough is then formed into a sheet and frozen to a temperature of about 32° F.

The sheet of frozen dough is then encased 130 by the main dough to form a folded dough. As used herein, encasing means placing the substance being used to separate the layers of main dough on a portion of the main dough sheet and folding the remaining portion of the main dough sheet over the substance. Also, as used herein, a folded dough comprises a layer of frozen dough between two layers of main dough.

The folded dough is then rolled out and folded 140 several times to form a multi-layered dough using equipment and methods known in the art, such as those employed in automated croissant lines and laminated pastry lines. As used herein, a multi-layer dough is a dough with at least five total layers, or two layers of frozen dough and three layers of main dough. Preferably, the rolling out and folding 140 is repeated to form at least 10 distinct layers of main dough.

Next, the multi-layered dough is sheeted 150 to, in one embodiment, a thickness of about 1.4 to 1.6 millimeters. Preferably, the dough is sheeted to a thickness of about 1.5 mm. The sheeted dough may be cut 160 into a desired shape. Some examples of shapes are a square, circle, triangle, crescent, rectangle, star, or oval, or the dough may be cut into random shapes in such a way that no dough scraps are produced. The shaped multi-layered dough is then proofed 170. As used herein, proofing is the process of allowing the dough to rise for a specified time prior to baking In one embodiment, the dough is proofed 170 for about 75 to 105 minutes at a relative humidity of about 90% and temperature of about 95° F. Preferably, the shaped multi-layered dough is proofed 170 for about 90 minutes. The time and relative humidity of this proofing operation 170 may vary according to the desired expansion of the final product. After proofing 170, the multi-layered dough is baked 180 to a moisture level of about 1.75% to 3.25%, preferably about 2.5%. In one embodiment, the dough is baked at about 266° F. to 302° F. for about 10 to 15 minutes and then at about 230° F. to 248° F. for about 35 to 85 minutes. Preferably, the multi-layered dough is baked at about 300° F. for about 10 minutes and at 240° F. for about 45 minutes. These sheeting, cutting, proofing and baking steps may all be accomplished with equipment and methods known in the art, such as those used in automated croissant lines.

In another embodiment of the present invention, ice is substituted for the prior art fat substance. Referring to FIG. 2, a main dough sheet is provided 210 as described above. Next, a layer of ice is placed 220 on a portion of the main dough sheet. As used herein, ice may be any frozen liquid including, but not limited to, frozen water, frozen fruit juice, or frozen vegetable juice. In one embodiment, shaved ice is used. Preferably, about 20 grams of shaved ice per 1,000 grams of dough is used to form the layer of ice on the main dough sheet. The ice is then encased 230 by the main dough to form an ice-layered dough. As used herein, an ice-layered dough is a layer of ice between two layers of main dough. While shaved ice is preferred because of its soft texture and ability to be manipulated within the dough layers without tearing or perforating the dough, any form of ice may be used so long as the ice sufficiently provides separation between the dough layers without tearing or perforation the dough and allows the ice-layered dough to be cut into shapes.

The ice-layered dough is then sheeted 240 to a desired thickness, cut 250 into a desired shape, proofed 260 and baked 270 as described above in conjunction with the multi-layered dough made with frozen dough.

### EXAMPLE 1

A main dough was prepared with the following composition: 6.13 pounds hard winter wheat flour, 0.042 pounds granulated sugar, 0.4 pounds vital wheat gluten, 0.218 pounds garlic powder, 0.152 pounds flour salt, 0.109 pounds yeast, and 2.949 pounds water. The dry ingredients were mixed using a Hobart Mixer for about 1 minute at speed 1. Water, at a temperature of about 65° F., was then added. The entire mixture was mixed in the Hobart Mixer for about 3 minutes at speed 1 and then for about 4 minutes at speed 2. The dough temperature measured about 80° F. The dough was allowed to ferment at room temperature for about 30 minutes. The main dough was formed into a sheet measuring about ¾ of an inch thick, about 14 inches wide and about 22 inches long, using a Rhondo Sheeter.

A frozen dough was prepared with the following composition: 3 pounds hard winter wheat flour, 3 pounds Xpandr SC natural pregelatinized starch, and 4 pounds water. The dry ingredients were mixed using a Hobart Mixer for about 1 minute at speed 1. Water, at a temperature of about 40° F., was then added. The entire mixture was mixed in the Hobart Mixer for about 3 minutes at speed 1 and then for about 6 minutes at speed 2. The dough temperature measured about 60° F. The dough was formed into a sheet, measuring about ¾ of an inch thick, about 14 inches wide and about 11 inches long, using a Rhondo Sheeter. The sheet was then cooled until its temperature reached 32° F.

The sheet of frozen dough was placed on half of the sheet of main dough. The other half of the sheet of main dough was folded over the sheet of frozen dough to form a folded dough, or a layer of frozen dough between two layers of main dough. The folded dough was then rolled out and folded 10 times to form a multi-layered dough of 10 layers. The multi-layered dough was then sheeted to a thickness of about 1.5 millimeters using a Rhondo Sheeter. The sheeted multi-layered dough was cut into squares of about 35 millimeters and the dough squares were proofed for about 90 minutes at a relative humidity of about 90% and a temperature of about 95° F. After proofing, the dough squares were baked for about 10 minutes at about 300° F. and about 45 minutes at about 240° F. to a moisture content of about 2.5%.

### EXAMPLE 2

A main dough was prepared with the following composition: 5.441 pounds hard winter wheat flour, 0.044 pounds granulated sugar, 0.481 pounds vital wheat gluten, 0.218 pounds garlic powder, 0.152 pounds flour salt, 0.544 pounds romano cheese paste, 0.109 pounds yeast, 0.163 pounds olive oil and 2.949 pounds water. The dry ingredients were mixed together using a Hobart Mixer for about 1 minute at speed 1. Water, at a temperature of about 65° F., was added. The entire mixture was mixed in the Hobart Mixer for about 3 minutes at speed 1 and then for about 6 minutes at speed 2. The dough temperature measured about 80° F. The dough was allowed to ferment at room temperature for about 30 minutes.

The main dough was then formed into a sheet. About 20 grams of shaved ice (frozen water) was placed on half of the sheet of main dough to form a layer of ice. The other half of the sheet of main dough was folded over the layer of shaved ice to form an ice-layered dough with a layer of shaved ice between two layers of main dough. The ice-layered dough was then sheeted to a thickness of about 1.5 millimeters using a Rhondo Sheeter. The sheeted ice-layered dough was cut into squares of about 35 millimeters and the dough squares were proofed for about 90 minutes at a relative humidity of about 90% and a temperature of about 95° F. After proofing, the dough squares were baked in a Dahlen Oven for about 10 minutes at about 300° F. and about 45 minutes at about 240° F. to a moisture content of 2.5%.

Using frozen dough to form the layered, flakey baked product is advantageous as it allows the final product to contain more layers. As described above, the folded dough (consisting of two layers of main dough and one layer of frozen dough) may be rolled out and folded several times to form a multi-layered dough consisting of many layers of frozen dough and many layers of main dough. However, when shaved ice is used, the ice-layered dough (consisting of a layer of shaved ice between two layers of main dough) cannot be further rolled out and folded. Thus, the finished layered, flakey product made with shaved ice only has three total layers, whereas the finished product made with frozen dough may have hundreds of layers. Also, the folded dough tends to be easier to process and handle as compared with the ice-layered dough.

The present invention may be modified in a number of ways by one skilled in the art within the scope of the invention. For example, the composition of the dough may be altered. The above-described dough is flour-based, but the dough may also be corn-based, rice-based or legume-based. Ingredients may be removed from or added to the dough formulation. Flavoring agents may be added to the dough to impart various flavors to the finished product. Possible flavoring agents include natural and synthetic flavorings such as vanilla, chocolate, cheese, butter, fruit, spices or other flavors. Also, food coloring may be added to the dough or shaved ice so that the finished product would have colored layers.

The above-described invention discloses a method for the production of a reduced fat, layered, flakey baked product. Although the invention has been particularly shown and described, the disclosure is not intended to limit the scope of the invention. It will be understood by those skilled in the art that various changes in form and conditions may be made therein without departing from the spirit and scope of the invention.

What is claimed is:

1. A method for producing a reduced fat layered baked product comprising the steps of:
a) providing a main dough;
b) providing a frozen dough;
c) encasing said frozen dough with said main dough to form a folded dough;
d) rolling out and folding said folded dough to form a multi-layered dough;
e) sheeting said multi-layered dough; and
f) baking said multi-layered dough.

2. The method of claim 1 wherein said baking at step f) comprises baking said multi-layered dough to a moisture content of about 1.75% to 3.25%.

3. The method of claim 1 wherein said baking at step f) comprises baking said multi-layered dough to a moisture content of about 2.5%.

4. The method of claim 1 wherein said sheeting at step e) comprises sheeting said multi-layered dough to a thickness of about 1.4 to 1.6 millimeters.

5. The method of claim 1 further comprising the step of cutting said multi-layered dough into a desired shape prior to step f).

6. The method of claim 5 wherein said desired shape is selected from the group comprising a square, circle, triangle, rectangle, crescent, star, or oval.

7. The method of claim 1 further comprising the step of proofing said multi-layered dough for about 75-105 minutes prior to step f).

8. The method of claim 7 wherein said multi-layered dough is proofed for about 90 minutes.

9. The method of claim 7 wherein said proofing is performed at a relative humidity of about 90% and a temperature of about 95° F.

10. The method of claim 1 wherein said main dough comprises wheat flour, granulated sugar, vital wheat gluten, garlic powder, flour salt, yeast, and water.

11. The method of claim 1 wherein said frozen dough comprises wheat flour, pregelatinized starch and water.

12. The method of claim 1 wherein step c) further comprises the steps of:
a) forming a sheet of said main dough;
b) forming a sheet of said frozen dough;
c) placing said sheet of said frozen dough on a portion of said sheet of said main dough; and
d) folding a remainder portion of said sheet of said main dough over said sheet of said frozen dough.

13. The method of claim 1 wherein said multi-layered dough comprises at least ten layers of main dough.

14. A reduced fat, layered baked product made by the method of claim 1.

15. A method for producing a reduced fat layered baked product comprising the steps of:
a) providing a main dough;
b) encasing ice with said main dough to form an ice-layered dough;
c) sheeting said ice-layered dough; and
d) baking said ice-layered dough.

16. The method of claim 15 wherein said ice comprises shaved ice.

17. The method of claim 15 wherein said ice is selected from the group comprising frozen water, frozen fruit juice, or frozen vegetable juice.

18. The method of claim 15 wherein said baking at step d) comprises baking said ice-layered dough to a moisture content of about 1.75% to 3.25%.

19. The method of claim 15 wherein said baking at step d) comprises baking said ice-layered dough to a moisture content of about 2.5%.

20. The method of claim 15 wherein said sheeting at step c) comprises sheeting said ice-layered dough to a thickness of about 1.4 to 1.6 millimeters.

21. The method of claim 15 further comprising the step of cutting said ice-layered dough into a desired shape prior to step d).

22. The method of claim 20 wherein said desired shape is selected from the group comprising a square, circle, triangle, rectangle, crescent, star or oval.

23. The method of claim 15 wherein further comprising the step of proofing said multi-layered dough for about 75-105 minutes prior to step d).

24. The method of claim 22 wherein said multi-layered dough is proofed for about 90 minutes.

25. The method of claim 22 wherein said proofing is done at a relative humidity of about 90% and a temperature of about 95° F.

26. The method of claim 15 wherein said main dough comprises wheat flour, granulated sugar, vital wheat gluten, garlic powder, flour salt, yeast, and water.

27. The method of claim 15 wherein about 20 grams of said ice is used per 1,000 grams of dough.

28. The method of claim 15 wherein step b) further comprises the steps of:
a) forming a sheet of said main dough;
b) placing said ice on a portion of said sheet of said main dough to form a layer of said ice; and
c) folding a remainder portion of said sheet of said main dough over said layer of said ice.

29. A reduced fat, layered baked product made by the method of claim 15.

30. A reduced fat, layered baked product comprising at least two distinct dough layers, wherein said dough layers were formed by separating said layers prior to baking with a non-fat frozen component.

31. The product of claim 30 wherein said frozen component comprises ice.

32. The product of claim 30 wherein said ice comprises shaved ice.

33. The product of claim 31 wherein said ice is selected from the group comprising frozen water, frozen fruit juice, or frozen vegetable juice.

34. The product of claim 30 wherein said frozen component comprises frozen dough.

35. The product of claim 33 wherein said product comprises at least ten distinct dough layers.

36. The product of claim 33 wherein said frozen dough comprises wheat flour, pregelatinized starch and water.

37. The product of claim 30 wherein said product comprises a moisture content of 1.75% to 3.25%.
